(19) United States
(12) Patent Application Publication
(10) Pub. No.: US 2016/0340915 A1
(43) Pub. Date: Nov. 24, 2016

(54) CONCRETE-MOSAIC

(71) Applicant: LITHOCRETE, INC., COSTA MESA, CA (US)

(72) Inventor: RONALD D. SHAW, CORONA DEL MAR, CA (US)

(21) Appl. No.: 14/718,318

(22) Filed: May 21, 2015

(51) Int. Cl. E04F 15/12; B28B 1/16; B28B 1/08; E04F 19/00

(52) U.S. Cl. CPC E04F 15/12; E04F 19/00; B28B 1/16; B28B 1/08

(57) ABSTRACT

A method of forming an aesthetic surface on a concrete structure. The aesthetic surface includes a mosaic design including a plurality of aesthetic elements, such as tiles, aggregate or the like, which are embedded within the hardened concrete structure. The aesthetic elements are affixed to the concrete form in the arrangement corresponding to the mosaic design prior to using the form during construction of the concrete structure. The concrete is poured into the form and allowed to harden, after which, the forms are stripped from the concrete, thereby exposing the embedded aesthetic elements within the concrete structure.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Field of the Invention

The present invention relates in general to concrete products and more particularly to methods for creating a mosaic within a surface of a concrete product.

2. Description of the Related Art

As is well known in the building and construction trade, concrete is extensively utilized as a building material for industrial, commercial and residential applications. Due to its durability, water resistance, and cost economy, concrete has gained widespread use. With this widespread use, the public is currently demanding variations in color, surface texture and overall appearance of concrete so that the concrete possesses improved aesthetics similar to more conventional and costly surfaces such as stone, mosaic, and terrazzo.

In order to meet this demand, the concrete trade has developed various coloring and surface finishing techniques to enhance the aesthetics of concrete. Examples of such finishing techniques include salt finish, multiple broom finish, form press finish (e.g. stamped concrete), and exposed aggregate finish.

In addition to the extensive use of concrete in building and construction, the use of mosaics in flooring, walls, and other decorative structures and elements has also become significantly widespread. Such products typically include a picture or decorative design. The design is generally constructed by completing several steps. First, with regard to flooring, for example, the flooring surface must be prepared, which may include leveling the surface. Secondly, an adhesive, such as mortar or a tile adhesive, is spread upon the surface. After the adhesive is in place, small individual colored mosaic pieces, such as stone or tile, are set into the surface. Once the adhesive is substantially dried, a grouting product is then set between the mosaic pieces to create a uniform surface and further secure the mosaic pieces to the surface. The resultant product is frequently very beautiful and may be very ornate and detailed. However, due to the extensive amount of time and several additional steps that such a product requires in comparison to other flooring products, mosaic flooring are usually quite expensive. Further, construction of mosaics in walls and other decorative structures and elements may also be quite laborious and expensive.

Although concrete and mosaic products have advanced significantly over recent years to meet the demands of customers and innovative builders, there is no current concrete product for use in flooring, walls, or other decorative structures and elements that makes the creation of mosaics more affordable or efficient than the basic process described above.

Therefore, there exists a need in the art for an improved process of creating mosaic products that is more cost and time efficient, particularly for creating a mosaic upon a vertical surface. Various aspects of the present invention are directed toward addressing this particular need, as will be discussed in more detail below.

### BRIEF SUMMARY

According to various aspects of the present invention, there is provided a method of forming an aesthetic surface on a concrete structure. When construction is complete, the aesthetic surface includes a mosaic design including a plurality of aesthetic elements, such as tiles, aggregate or the like, embedded within the hardened concrete structure. The method of forming the aesthetic surface includes affixing the aesthetic elements to the concrete form in the arrangement corresponding to the mosaic design prior to using the form during construction of the concrete structure. The concrete is then poured into the form and allowed to harden, after which, the forms are stripped from the concrete, thereby exposing the embedded aesthetic elements within the concrete structure.

According to one embodiment, the method of forming the aesthetic surface includes providing a plurality of aesthetic elements and a concrete form, and adhering the aesthetic elements directly to the concrete form with a water soluble adhesive. The method further includes pouring concrete into the form, and removing the form from the concrete.

The method may additionally include the step of vibrating the concrete poured in the form to release water from the concrete for dissolving the water soluble adhesive.

The method may further include trowelling a surface of the concrete and sponging the concrete to expose the aesthetic elements.

The method may additionally include the step of allowing the concrete to harden. The step of removing the forms from the concrete may be performed within 48 hours of completing the pouring step. The step of removing the forms may also be performed within 18 hours of completing the pouring step. In other embodiments, the step of removing the forms may be performed more than 48 hours after completing the pouring step.

The method may additionally include the step of exposing the aesthetic elements. The aesthetic elements may include aggregates and/or tiles. The aesthetic elements may be adhered to the concrete form in a random arrangement. Alternatively, the aesthetic elements may be adhered to the concrete form in an arrangement corresponding to a prescribed design.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an upper perspective view of a tile mosaic formed on a vertical concrete surface;

FIG. 2 is an upper perspective view of a plurality of tiles which collectively define the mosaic, and a transfer form for use in forming the mosaic within the concrete surface;

FIG. 3A is a top view of a concrete form defining a pour area, with the mosaic tiles disposed inside the pour area adjacent the form, the tiles being secured to the transfer form via an adhesive;

FIG. 3B is a top view similar to FIG. 3A, with concrete poured into the pour area defined by the concrete form;

FIG. 3C is a top view similar to FIG. 3B with the concrete hardened and the form removed from the hardened concrete and mosaic tiles; and

FIG. 3D is a top view similar to FIG. 3C with the adhesive removed from the tiles.

Common reference numerals are used throughout the drawings and detailed description to indicate like elements.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

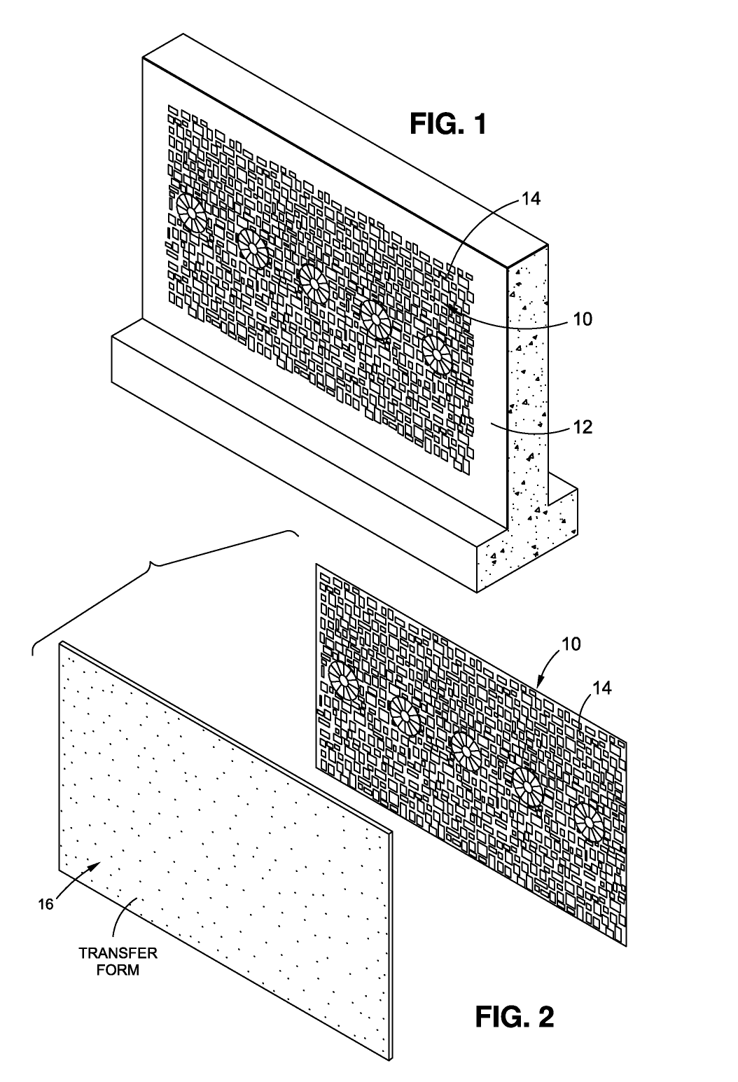

Referring now to the drawings wherein the showings are for purposes of illustrating a preferred embodiment of the invention only, and not for purposes of limiting the same, FIGS. 1-3D show a system and method of easily creating and installing a mosaic 10 comprised of a plurality of tiles 14 upon a concrete surface 12, particularly a vertical concrete surface 12. As will be described in more detail below, various aspects of the present invention are directed toward transferring the plurality of mosaic tiles 14 to the concrete via at least one concrete form member (i.e., referred to herein as the “transfer form” 16) which is additionally used for constructing and shaping the concrete. In this regard, the transfer form 16 may be used in combination with several conventional concrete forms to define a pour area for the concrete. The mosaic tiles 14 may be connected to the transfer form 16 before the concrete is poured into the pour area. After the concrete has hardened, the forms may be removed, leaving the mosaic tiles 14 embedded within the concrete in the arrangement corresponding to the mosaic pattern or compilation.

Several techniques have been previously developed for imparting a mosaic design into a concrete structure. Exemplary of such previously developed techniques are the methods described in U.S. patent application Ser. Nos. 13/294,434 and 13/783,052, both of which are owned by Lithocrete, Inc. (the owner of the present application), and the contents of which are expressly incorporated herein by reference. The aforementioned United States patent applications describe a method wherein a plurality of tiles comprising a mosaic design is transferred to a concrete structure through the use of a transfer template, which is separate from the concrete form members and is typically fabricated from a mesh material. In particular, the mosaic tiles are affixed to the transfer template in an arrangement corresponding to mosaic design. The template is then attached to the concrete forms before the concrete is poured. In some cases the template remains in the concrete after the concrete hardens, while in other cases, the template is removed concurrently or shortly after removal of the forms from the concrete.

Although the use of the transfer template is effective for transferring the mosaic pattern to the concrete structure, various aspects of the present invention are directed toward improving the previously developed methods by eliminating the need for the transfer template. In particular, several embodiments of the present invention allow the mosaic tiles to be coupled directly to the concrete form, and thus, the transfer template is not needed in such instances.

Referring now specifically to FIG. 1, the concrete structure is shown with the mosaic 10 exposed on a generally vertical surface 12 of the concrete structure. As used herein, the word “vertical” refers to a direction having a directional component aligned with an axis defined by the force of gravity (i.e., the gravitational axis). A vertical face may extend generally upward from a lower support, or generally downward from an upper support. “Vertical” may also indicate a direction that is substantially perpendicular to the horizontal. Along these lines, a vertical surface is not limited to being substantially upright or perpendicular to the horizontal. In this regard, the vertical surface may be slightly offset from the perpendicular to the horizontal.

The mosaic 10 shown in the concrete structure depicted in FIG. 1 includes a plurality of tiles 14 arranged in a mosaic pattern or other aesthetic arrangement. As used herein, the word “tile” may refer to any aesthetic element used in forming the mosaic, and may include aggregates, stones, shells, glass, other aesthetic materials known by those skilled in the art, and combinations thereof.

Referring now to FIG. 2, the tiles 14 used in forming the mosaic 10 are adhered to the transfer form member 16 in an arrangement corresponding to the mosaic pattern. The transfer form member 16 may be a conventional form member used in forming shaping concrete, and may be fabricated from wood or other materials known by those skilled in the art. The transfer form member 16 is sized and configured to include sufficient rigidity and strength to support the totality of tiles 14 used in forming the mosaic design 10 during the transfer process. As will be described in more detail below, the tiles 14 are adhered to the transfer form 16 to maintain the tiles 14 in position on the transfer form 16 while the concrete is poured into a pour cavity, as well as to maintain the tiles 14 in position during the hardening process.

When the tiles 14 are adhered to the transfer form 16, an artist may create the mosaic arrangement during the process of placing the tiles 14 on the form member 16. Alternatively, the mosaic 10 may be printed or traced on the form 16 to serve as a guide for placing the tiles thereon. As yet another alternative, the concrete form 16 may include a plurality of recesses or cavities formed therein, wherein each tile 14 may be placed within respective ones of the recesses or cavities so as to simplify arrangement of the tiles 14 on the form 16.

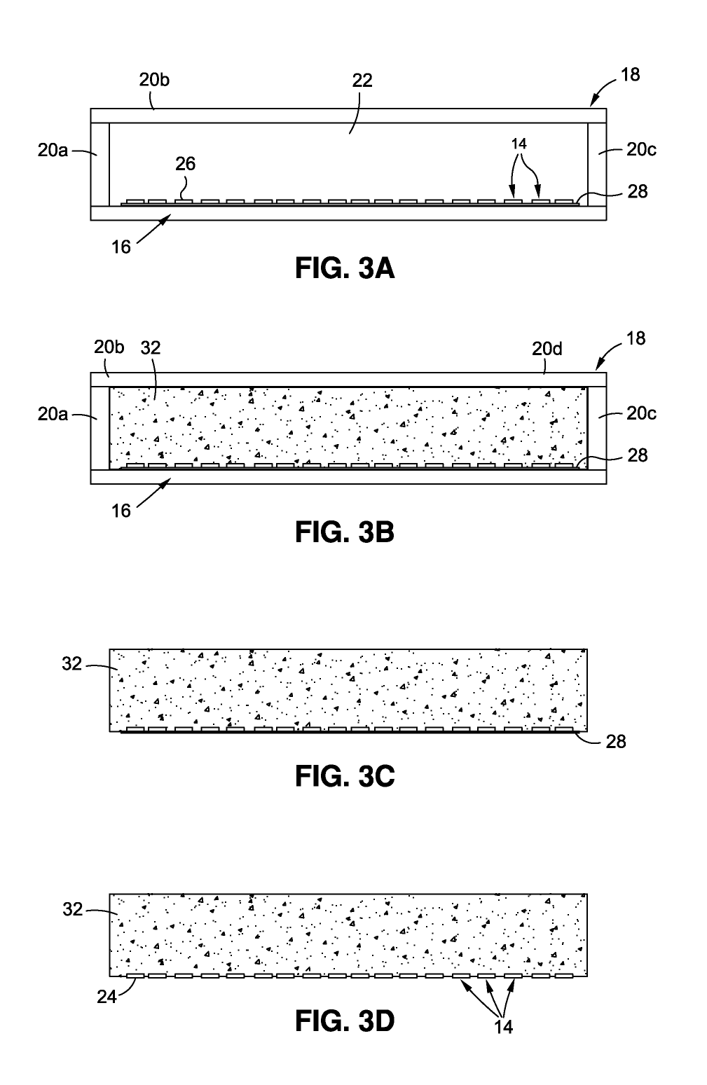

Referring now to FIG. 3A, there is shown a concrete form 18 including conventional form members 20a-20c and transfer form member 16 for constructing a concrete structure. The form 18 is placed upon a base or ground surface, and defines a pour cavity 22 corresponding to the desired shaped of the concrete structure. The form 18 shown in FIGS. 3A and 3B includes three conventional form members 20a-20c and a single transfer form 16, which collectively define the pour cavity 22. Each form member 20a-20c and transfer form 16 defines an inner face and an outer face, with the inner faces of the form members 16, 20a-20c defining the pour cavity 22. Transfer form member 16 may be generally referred to as the “face form” because it corresponds to the face of the concrete structure. Although the form members 16, 20a-20c shown in FIGS. 3A and 3B are planar, it is additionally contemplated that other embodiments may include form members 16, 20a-20c that define other shapes and configurations, such as arcuate or rounded sections. Furthermore, the form 18 shown in FIGS. 3A and 3B defines a pour cavity 22 that is completely circumscribed by the concrete form 18, however, it is understood that the form 18 may only partially circumscribe the cavity 22. For instance, the form 18 may be placed against an existing structure, wherein a portion of the existing structure defines a portion of the cavity 22. The form members 16, 20a-20c defining the form are held together by mechanical fasteners, such as nails or screws, to define the cavity 22 within which the concrete is poured.

Referring now to FIGS. 3A and 3D each tile 14 includes an exposed surface 24 (See FIG. 3D) and an embedded surface 26 (See FIG. 3A). The tiles 14 are configured to be placed within the concrete structure such that the embedded surface 26 is embedded within the concrete, while the exposed surface 24 remains exposed to contribute to the overall appearance of the mosaic 10. The tiles 14 may be formed of ceramic, glass, stone, shell, and/or brick tile pieces, and any other variety of ornamental material or combinations thereof. Furthermore, the tiles 14 are preferably configured to withstand the environmental conditions associated with the location of the concrete structure. For instance, if the concrete structure is located outside, the tiles 14 should be configured to endure extended periods of exposure to the sunlight, as well as temperature changes, precipitation, or other conditions commonly associated with the local environment. A protective coating may be applied to the tiles 14 to provided added protection from the environmental elements.

According to one embodiment, the exposed surfaces 24 of the tiles 14 are temporarily adhered to the transfer form 16 in an arrangement that is a “reverse image” configuration, such that when the tiles 14 are embedded to the vertical surface 12 of the concrete structure, the tiles 14 appear in the correct configuration. However, as noted above, the tiles 14 may also be arranged in a random fashion on the vertical surface 12.

An adhesive 28 may be disposed between the tiles 14 and the transfer form 16 to temporarily adhere the tiles 14 to the transfer form 16. The adhesive 28 is preferably a water soluble adhesive 28 to facilitate separation of the transfer form 16 from the tiles 14 after the concrete hardens and the tiles 14 are embedded within the concrete structure.

In one particular implementation, the adhesive 28 is disposed on the transfer form 16 prior to placing the tiles 14 on the form 16 in the mosaic arrangement, i.e., the tiles 14 are arranged to a define a prescribed pattern or shape, or alternatively, the tiles 14 are arranged in a random configuration. In this regard, it may be easier to apply the adhesive 28 to the transfer form 16, rather than applying the adhesive 28 to each tile 14 individually. After the adhesive 28 is completely disposed on the transfer form 16, the tiles 14 are then placed on the thereon.

According to another implementation, the adhesive 28 is applied to the exposed surface 24 of the tiles 14 before the tiles 14 are placed on the transfer form 16. Applying the adhesive 28 to each individual tile 14 may result in a more efficient use of the adhesive 28 (i.e., less adhesive 28 may be used), although it may be more time consuming. After the adhesive 28 has been placed on the tiles 14, the tiles 14 may be placed upon the form 16, with the adhesive 28 being disposed between the exposed surface 24 of the tiles 14 and the form 16.

The form 16 and the tiles 14 placed thereon are connected to the remaining form members to dispose the tiles 14 within the pour cavity 22. The transfer form 16 is arranged with the embedded surfaces 26 of the tiles 14 facing into the cavity 22 and the exposed surfaces 24 of the tiles 14 facing out of the cavity 22 (i.e., toward the adjacent form member).

The concrete 32 is poured into the pour cavity 22 and is allowed to settle and set-up/harden. During at least a portion of the hardening process, the transfer form 16 remains in place. It is contemplated that the tiles 14 may become partially or completely embedded within the concrete 32 when the concrete 32 is poured into the cavity 22. However, as discussed in more detail below, a finishing process may be performed to remove a portion of the concrete 32 and thereby uncover the exposed surfaces 24.

After the concrete 32 has been poured, the form 18, including the transfer form member 16, is removed from the concrete structure and the tiles 14. According to one implementation, the form 18 is removed while the concrete is in a semi-plastic state. The transfer form 16 may be configured to peel away from the tiles 14 when the form 18 is removed from the concrete structure.

When a water soluble adhesive is used, the concrete may be vibrated to cause the moisture from the concrete to release and travel along the interface of the form 16 and the tiles 14 thereby deactivating/dissolving the water-based adhesive 28 adhering the tiles 14 to the form 16. Other methods known in the art of dissolving or otherwise rendering the adhesive 28 inoperable may also be used, such as spraying water or applying another agent onto the transfer form 16. After the adhesive 28 has been dissolved, the transfer form 16 may be separated from the tiles 14, leaving the tiles 14 embedded within the concrete 32. Once the adhesive 28 is deactivated, the form 16 may be easily pulled/stripped from the concrete structure.

An optional finishing step may be performed to the concrete structure and the tiles 14 after the form 18 has been removed. For instance, a float may be passed over the tiles 14 and concrete before the concrete sets up, so as to create a more uniform surface. The concrete structure may be sandblasted, acid washed, brushed, sponged, or power washed to remove the top layer of concrete 32, which may further uncover the tiles 14 to more prominently display the mosaic 10, as well as to expose the concrete fines to produce a more aesthetic appearance. In addition, a surface retarder may be applied to the form 18 or concrete directly to more prominently display the mosaic 10.

The foregoing generally describes the steps of forming the aesthetic surface on the concrete structure. However, there are slight modifications to the process depending on whether the wall is “short” or “tall.” According to one embodiment, a short wall is a wall up to eight (8) feet, while a tall wall can range anywhere from four (4) feet to twenty (20) feet, and in some cases higher. For shorter walls, the concrete form 18 may be stripped from the concrete structure on the same day that the concrete is poured. In this regard, the concrete form 18 may be stripped within 24 hours after the concrete is poured. It is also contemplated that the concrete form 18 may be stripped within 18 hours or even 12 hours of pouring the concrete.

After the concrete form 18 is stripped, the aesthetic surface may be floated or trowelled and the tiles/aggregates 14 may be exposed. The concrete surface 12 may be sponged to expose the tiles/aggregates 14. The concrete structure may then continue to harden.

With regard to taller walls, the concrete form 18 may be stripped a day after the concrete is poured into the form 18, in particular, more than 24 hours after the concrete is poured. After the form 18 is stripped, the concrete structure may be washed with a surface retarder to expose the aggregates 14. The concrete structure may then continue to harden.

The above description is given by way of example, and not limitation. Given the above disclosure, one skilled in the art could devise variations that are within the scope of the invention disclosed herein, including various ways of creating different textures, colors, patterns, utilizing various types of mosaic pieces, etc. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of forming an aesthetic surface on a concrete structure, the method comprising the steps of:
providing a plurality of aesthetic elements and a concrete form;
adhering the aesthetic elements directly to the concrete form with a water soluble adhesive;
pouring concrete into the form; and
removing the form from the concrete.

2. The method recited in claim 1, further comprising the step of vibrating the concrete poured in the form to release water from the concrete for dissolving the water soluble adhesive.

3. The method recited in claim 1, further comprising the step of trowelling a surface of the concrete.

4. The method recited in claim 3, further comprising the step of sponging the concrete to expose the aesthetic elements.

5. The method recited in claim 4, further comprising the step of allowing the concrete to harden.

6. The method recited in claim 1, wherein the removing step is performed within 48 hours of completing the pouring step.

7. The method recited in claim 6, wherein the removing step is performed within 18 hours of completing the pouring step.

8. The method recited in claim 1, wherein the removing step is performed more than 48 hours after completing the pouring step.

9. The method recited in claim 1, wherein the aesthetic elements include aggregates.

10. The method recited in claim 10, wherein the aggregates are adhered to the concrete form in a random arrangement.

11. The method recited in claim 1, wherein the aesthetic elements include tiles.

12. The method recited in claim 1, wherein the aesthetic elements are adhered to the concrete form in an arrangement corresponding to a prescribed design.

13. A method of forming an aesthetic surface on a concrete structure, the method comprising the steps of:
providing a plurality of aesthetic elements and a concrete form;
affixing the aesthetic elements directly to the concrete form;
pouring concrete into the form; and
removing the form from the concrete.

14. The method recited in claim 13, further comprising the step of vibrating the concrete poured in the form to release water from the concrete for dissolving the water soluble adhesive.

15. The method recited in claim 13, wherein the removing step is performed within 48 hours of completing the pouring step.

16. The method recited in claim 13, wherein the removing step is performed more than 48 hours after completing the pouring step.

17. The method recited in claim 13, wherein the aesthetic elements include aggregates.

18. The method recited in claim 13, wherein the aesthetic elements include tiles.

19. The method recited in claim 13, wherein the aesthetic elements are adhered to the concrete form in a random arrangement.

20. The method recited in claim 13, wherein the aesthetic elements are adhered to the concrete form in an arrangement corresponding to a prescribed design.
